(19) United States
(12) Patent Application Publication
(10) Pub. No.: US 2014/0035751 A1
(43) Pub. Date: Feb. 6, 2014

(54) ABNORMALITY DIAGNOSIS APPARATUS FOR COOLING SYSTEM

(71) Applicants: Yoshihisa Shinoda, Susono-shi (JP); Kazuhiro Sugimoto, Susono-shi (JP); Hiroshi Tanaka, Susono-shi (JP)

(72) Inventors: Yoshihisa Shinoda, Susono-shi (JP); Kazuhiro Sugimoto, Susono-shi (JP); Hiroshi Tanaka, Susono-shi (JP)

(73) Assignee: TOYOTA JIDOSHA KABUSHIKI KAISHA, Toyota-shi (JP)

(21) Appl. No.: 13/959,066

(22) Filed: Aug. 5, 2013

(30) Foreign Application Priority Data
Aug. 6, 2012 (JP) 2012-174142

(51) Int. Cl. G01N 25/72

(52) U.S. Cl. CPC G01N 25/72
USPC 340/588; 374/5

(57) ABSTRACT

An abnormality diagnosis apparatus for a cooling system includes a cooling portion that is formed in the component of the cooling system and has an internal flow path for flowing a coolant, a non-cooling portion that is formed in the component and has a closed flow path obtained by closing at least a part of the internal flow path, and an abnormality diagnosis portion that performs abnormality diagnosis of the cooling system based on temperature characteristics of the cooling portion and temperature characteristics of the non-cooling portion during flowing of the coolant.

### INCORPORATION BY REFERENCE

The disclosure of Japanese Patent Application No. 2012-174142 filed on Aug. 6, 2012 including the specification, drawings and abstract is incorporated herein by reference in its entirety.

### BACKGROUND OF THE INVENTION

1. Field of the Invention

The invention relates to an abnormality diagnosis apparatus for a cooling system.

2. Description of Related Art

Conventionally, there is available a direct ozone reduction (DOR) system in which a catalyst capable of reducing ozone is provided in a vehicle-mounted cooling system represented by, e.g., a radiator, and ozone in air is directly reduced during running of the vehicle. In addition, in the DOR system mentioned above, there is available an apparatus for diagnosing the presence or absence of the illicit modification (what is called tampering) of the above cooling system.

As the apparatus for diagnosing the presence or absence of tampering, for example, U.S. Pat. No. 7,567,884 discloses an apparatus for diagnosing the presence or absence of tampering by comparing the actually measured value of a temperature gradient (temperature increase degree) in the cooling system with the estimated value thereof. In this apparatus, the above-mentioned actually measured value is determined from the detection value of a temperature sensor installed at the core of a heat exchanger or on the outside of a coolant pipe on the downstream side of the heat exchanger, the estimated value is determined from the detection value of a sensor capable of detecting parameters related to a coolant temperature (an engine revolutions per minute (RPM), an emission amount, a vehicle speed, and the like), and it is determined that tampering is present as a result of the diagnosis in a case where a difference between the actually measured value and the estimated value is not less than a set value,

In addition, for example, Japanese Patent Application Publication No 2010-071079 (JP-2010-071079 A) discloses an apparatus that diagnoses the presence or absence of tampering by measuring and estimating the temperature of the coolant flown in a radiator using two temperature sensors, and comparing the two temperatures. Specifically, in this apparatus, while the coolant is flown in the radiator, the temperature is measured by using the temperature sensor provided in the vicinity of the exit of the coolant of the radiator, the temperature is estimated from the temperature sensor provided in a cylinder block, and it is determined that tampering is present in a case where a difference between the temperatures is not less than a set value.

Both in U.S. Pat. No. 7,567,884 and JP-2010-071079 A, the actual temperature in the cooling system is measured by the temperature sensor, and the diagnosis of tampering is performed based on the actual temperature. Consequently, this conventional apparatus configuration is based on the combination of the temperature sensor and a diagnosis process apparatus. However, a temperature measurement test conducted by the inventors indicated a possibility that it was not possible to precisely detect tampering with the radiator with such an apparatus configuration. A description will be given of the temperature measurement test with reference to FIGS. 10 and 11.

FIG. 10 is a schematic diagram of the temperature measurement test. As shown in FIG. 10, the temperature measurement test was performed by mounting, on a radiator 50, three temperature sensors, i.e., a normal sensor 52 corresponding to a legitimate mounted sensor, and abnormality sensors 54, 56 corresponding to tampering sensors, and measuring each temperature within a predetermined time period after the start of flowing of a long life coolant (LLC). Note that, similarly to the normal sensor 52, the abnormality sensor 54 was installed on the surface of the radiator 50. The abnormality sensor 56 was installed on a coolant pipe 58 on the downstream side of the radiator 50.

FIG. 11 is a view showing the result of the temperature measurement test. As shown in FIG. 11, between the abnormality sensor 54 and the normal sensor 52, there was no significant difference in the behavior of the measured temperature. In addition, between the abnormality sensor 56 and the normal sensor 52, although different temperature behaviors were observed temporarily, there was no significant difference in temperature gradient immediately after the start of the flowing.

Since the actual temperature mentioned above corresponds to the temperature measured by the normal sensor 52, in a case where there is no significant difference in the temperature behavior between the normal sensor 52 and the abnormality sensor 54 or 56, it follows that the actual temperature may be measured by the abnormality sensor 54 or 56, That is, this means that tampering can be easily conducted with the above apparatus configuration. For example, if the legitimate radiator 50 is tampered with and is connected to the diagnosis process apparatus with the abnormal sensor 54 or 56 attached to the radiator 50, there has been a possibility that the diagnosis process apparatus determines that the radiator 50 is the legitimate radiator as a result of the diagnosis. Accordingly, the development of the apparatus having the configuration that makes it difficult to conduct tampering has been required.

### SUMMARY OF THE INVENTION

The invention provides an abnormality diagnosis apparatus for a cooling system capable of diagnosing the presence or absence of tampering with the cooling system.

A first aspect of the invention is an abnormality diagnosis apparatus for a cooling system including a cooling portion that is formed in a component of the cooling system and includes an internal flow path for flowing a coolant, a non-cooling portion that is formed in the component and includes a closed flow path obtained by closing at least a part of the internal flow path, and an abnormality diagnosis portion that performs abnormality diagnosis of the cooling system based on a temperature characteristic of the cooling portion and a temperature characteristic of the non-cooling portion during flowing of the coolant.

According to the above configuration, it is possible to perform the abnormality diagnosis of the cooling system based on the temperature characteristic of the cooling portion and the temperature characteristic of the non-cooling portion during the flowing of the coolant. The cooling portion is formed in the component of the cooling system and includes the internal flow path for flowing the coolant, and the non-cooling portion is formed in the component and includes the closed flow path obtained by partially closing the internal flow path. According to the configuration with the cooling portion and the non-cooling portion, a clear difference between the temperature characteristics thereof is generated. Therefore, it is possible to provide the abnormality diagnosis apparatus for the cooling system that uses such a difference between the temperature characteristics.

According to a second aspect of the invention, the abnormality diagnosis portion may perform the abnormality diagnosis based on a difference between a convergence temperature of the non-cooling portion and a convergence temperature of the cooling portion that are obtained after start of the flowing of the coolant into the internal flow path,

After the start of the flowing of the coolant, the temperature of the cooling portion and the temperature of the non-cooling portion converge to respective specific temperatures. However, since the non-cooling portion includes the closed flow path formed by partially closing the internal flow path, the non-cooling portion has the structure in which heat of the coolant is less likely to be conducted. Consequently, the convergence temperature of the non-cooling portion is lower than the convergence temperature of the cooling portion. In this point, according to the above configuration, it is possible to perform the abnormality diagnosis of the cooling system based on the convergence temperature difference. Therefore, it is possible to detect the abnormality of the cooling system with high probability.

According to a third aspect of the invention, the abnormality diagnosis portion may perform the abnormality diagnosis based on a difference between a time required for a temperature of the non-cooling portion to converge and a time required for a temperature of the cooling portion to converge after start of the flowing of the coolant into the internal flow path.

As described in conjunction with the second aspect, after the start of the flowing of the coolant, the temperature of the cooling portion and the temperature of the non-cooling portion converge to respective specific temperatures. However, since the non-cooling portion has the closed flow path formed by partially closing the internal flow path, heat conduction requires a longer time. Consequently, the necessary time required for the non-cooling portion to reach the convergence temperature is longer than the necessary time required for the cooling portion to reach the convergence temperature. In this point, according to the above configuration, it is possible to perform the abnormality diagnosis of the cooling system based on the necessary time difference. Therefore, it is possible to detect the abnormality of the cooling system with high probability.

According to a fourth aspect of the invention, the coolant may be for cooling an internal combustion engine, the internal flow path may include a shared common flow path on a downstream side of the internal flow path, the closed flow path may be formed by closing a part of the internal flow path on an upstream side and may be structured to allow the coolant from the common flow path to flow backward, and the abnormality diagnosis portion may estimate a necessary time required for a temperature of the non-cooling portion to converge after start of the flowing of the coolant into the internal flow path based on an RPM of the internal combustion engine, a coolant temperature on the upstream side of the internal flow path, and a temperature of the cooling potion at a time point of the start of the flowing of the coolant into the internal flow path, and may perform the abnormality diagnosis by comparing the estimated necessary time with an actual necessary time required for the temperature of the non-cooling portion to converge after the start of the flowing of the coolant into the internal flow path.

In a case where the closed flow path is formed by closing a part of the internal flow path on the upstream side, the closed flow path is structured to allow the coolant from the common flow path to flow backward. Herein, in a case where the coolant flows backward in the internal flow path, it is possible to estimate the necessary time required to reach the convergence temperature of the non-cooling portion based on the RPM of the internal combustion engine, the coolant temperature on the upstream side of the internal flow path, and the temperature of the cooling portion at the time point of the start of the flowing of the coolant into the internal flow path. In this point, according to the above configuration, by comparing the estimated necessary time with the actual necessary time, it is possible to perform the abnormality diagnosis of the cooling system. Therefore, it is possible to detect the abnormality of the cooling system with high probability.

According to a fifth aspect of the invention, the closed flow path may be formed of a material having a thermal conductivity lower than that of a material used for the internal flow path.

According to the above configuration, since it is possible to close the closed flow path with the material having the thermal conductivity lower than that of the material used for the internal flow path, it becomes possible to generate the above-described difference between the temperature characteristics while minimizing a reduction in the cooling capability of the cooling system caused by the closing.

According to a sixth aspect of the invention, the closed flow path may be formed of a material having a thermal expansion coefficient higher than that of a material used for the internal flow path.

According to the above configuration, since it is possible to close the closed flow path with the material having the thermal expansion coefficient higher than that of the material used for the internal flow path, it is possible to expand the closing material as compared with the surrounding material for the internal flow path during the rise of the temperature of the cooling system. Therefore, it is possible to prevent formation of a gap in the closed flow path.

According to a seventh aspect of the invention, an alarm lamp may be turned on or driving in a fail-safe mode may be performed when an abnormality in the cooling system is determined as a result of the abnormality diagnosis.

According to the above configuration, in the case where it is determined that the abnormality is present in the cooling system as a result of the abnormality diagnosis, it becomes possible to urgently take countermeasures such as turning on of the alarm lamp or the driving in the fail-safe mode.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing the configuration of a vehicle on which an abnormality diagnosis apparatus of a first embodiment is mounted;

FIG. 2 is a front view of a radiator 14 of FIG. 1;

FIG. 3 is a view for explaining the flow of a coolant in the radiator 14;

FIG. 4 is a view for explaining temperature behaviors measured by temperature sensors 16, 18;

FIG. 5 is a flowchart showing a tampering diagnosis process executed by an electric control unit (ECU) 40 in the first embodiment;

FIG. 6 is a schematic diagram of a diagnosis process apparatus with a temperature measurement function;

FIG. 7 is a view for explaining the flow of the coolant in the radiator 14;

FIG. 8 is a view for explaining temperature behaviors measured by temperature sensors 16, 18;

FIG. 9 is a flowchart showing the tampering diagnosis process executed by the ECU 40 in a second embodiment;

FIG. 10 is a schematic diagram of a temperature measurement test; and

FIG. 11 is a view showing the result of the temperature measurement test.

### DETAILED DESCRIPTION OF EMBODIMENTS

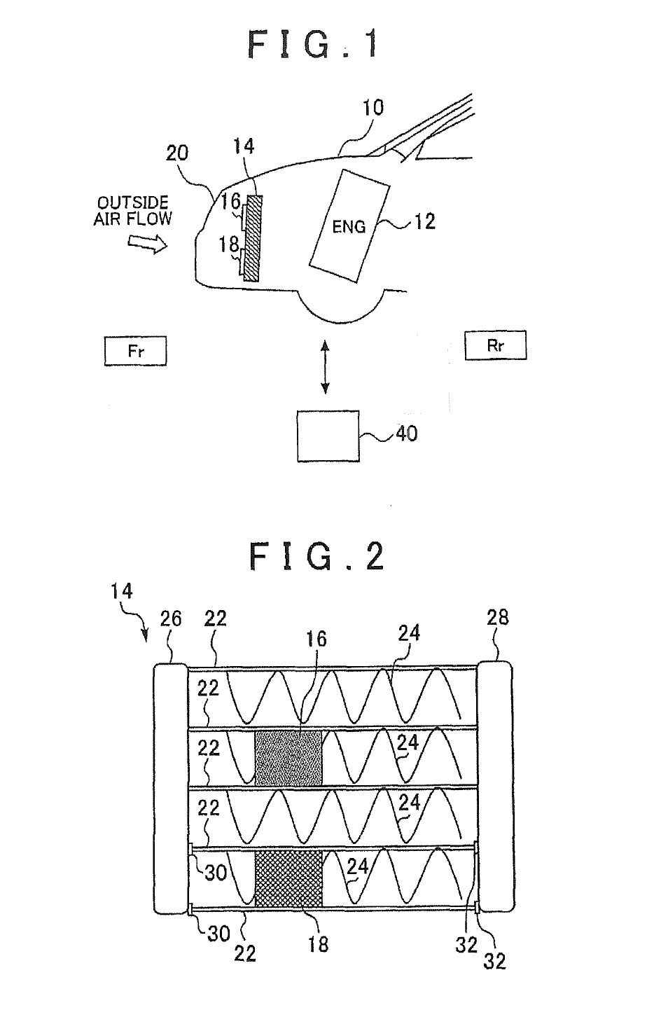

First, with reference to FIGS. 1 to 6, a first embodiment of the invention will be described, FIG. 1 is a view showing the configuration of a vehicle on which an abnormality diagnosis apparatus of the first embodiment is mounted. As shown in FIG. 1, a vehicle 10 includes an internal combustion engine 12 as a power unit. Exhaust gas emitted from the internal combustion engine 12 contains HC and NOx. Ozone is generated by a photochemical reaction with HC and NOx as reactants. Consequently, in a case where the component of the vehicle 10 is provided with an ozone reduction function, it is possible to reduce ozone in air during running of the vehicle 10 to reduce an influence on an environment by the vehicle 10.

A radiator 14 is disposed as the component forward of the internal combustion engine 12. The radiator 14 cools a coolant circulated in the internal combustion engine 12. A coolant circulation system including the radiator 14 functions as a cooling system of the invention. The core of the radiator 14 is coated with an ozone reducing substance having an ozone reduction function. The ozone reducing substance is a substance that decomposes and reduces ozone in air by utilizing radiant heat in the radiator 14. Examples of the ozone reducing substance include metal oxides such as manganese dioxide and the like and porous materials such as activated carbon and zeolite. Further, in addition to the metal oxides and the porous materials, there can be used materials that use single metals such as manganese, iron, cobalt, nickel, copper, ruthenium, rhodium, palladium, silver, platinum, and gold, and metal complexes and organic metal complexes having these single metals as central metals.

To the radiator 14, temperature sensors 16, 18 are attached. The temperature sensors 16, 18 are configured to be capable of measuring the temperatures of specific parts of the radiator 14 (details thereof will be described later). In front of the temperature sensors 16, 18, a bumper grille 20 is provided on the front face of the vehicle 10. As indicated by an arrow in FIG. 1, during running of the vehicle 10, air is taken in from the bumper grille 20, and the air taken into the vehicle passes through the radiator 14 and is discharged rearward.

In addition, the vehicle 10 includes an ECU 40 as a control unit. To the input side of the ECU 40, besides the above-described temperature sensors 16, 18, there are connected an engine water temperature sensor (not shown) that detects the temperature (engine water temperature) of the coolant flowing on the upstream side of the radiator 14, a crank angle sensor (not shown) that detects an engine RPM, and a thermostat (not shown) that allows or prohibits the flowing of the coolant to the radiator 14 by its opening and closing. To the output side of the ECU 40, a malfunction indicator lamp (MIL) and various actuators are connected.

FIG. 2 is a front view of the radiator 14 of FIG. 1. The core of the radiator 14 is constituted by a plurality of tubes 22 and wave-shaped fins 24 connected to the outer surfaces of the tubes 22. Each tube 22 and each fine 24 are made of aluminum or an aluminum alloy (an alloy of which mechanical properties are reinforced by adding copper, zinc, iron, magnesium, silicon, nickel, manganese, or titanium to aluminum). The fin 24 is provided for the purpose of increasing the area of the outer surface of the tube 22 to improve efficiency of heat exchange performed between the coolant flowing in the tube 22 and outside air. The tubes 22 and the fins 24 are incorporated into header tanks 26, 28 that extend in a direction orthogonal to the longitudinal direction of the tube 22.

In addition, as shown in FIG. 2, the radiator 14 includes closed portions 30, 32. The closed portions 30, 32 are formed by closing both ends of the tubes 22. The temperature sensor 18 is attached to the core including the tube 22 formed with the closed portions 30, 32 (hereinafter referred to as a “worked portion”). The temperature sensor 16 is attached to the core including the tube 22 that is not subjected to closing work (hereinafter referred to as an “unworked portion”).

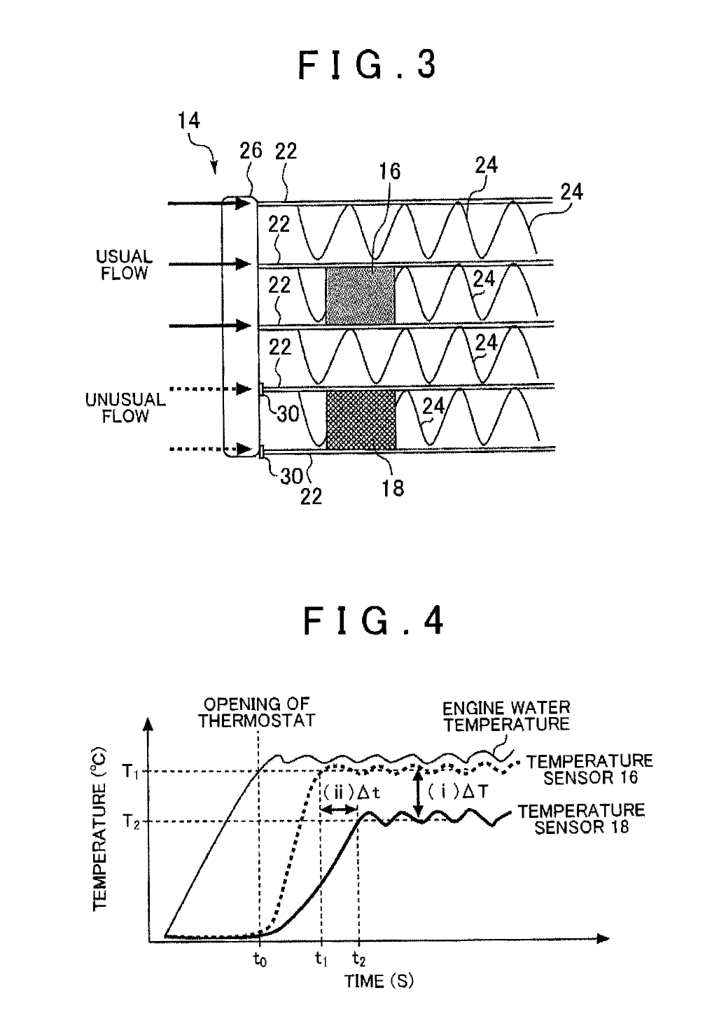

FIG. 3 is a view for explaining the flow of the coolant in the radiator 14. The coolant flows into each of the tubes 22 via the header tank 26, and is discharged from the header tank 28. Herein, in the tube 22 that is not subjected to the closing work, the coolant flows. That is, a usual flow of the coolant is generated. On the other hand, in the tube 22 formed with the closed portions 30, 32, the flow of the coolant is blocked, or only an extremely small amount of the coolant flows. That is, an unusual flow of the coolant is generated. Therefore, the temperature measured by the temperature sensor 18 and the temperature measured by the temperature sensor 16 exhibit different behaviors.

FIG. 4 is a view for explaining the temperature behaviors measured by the temperature sensors 16, 18. The coolant flows into the radiator 14 by opening of the thermostat (Time t₀), When the thermostat opens, the usual flow of the coolant is generated in the tube 22 that is not subjected to the closing work. Consequently, the temperature measured by the temperature sensor 16 sharply rises after the valve opening of the thermostat to approach the engine water temperature and, thereafter, converges to a specific temperature T₁ (Time t₁). On the other hand, the unusual flow of the coolant is generated in the tube 22 formed with the closed portions 30, 32. Consequently, the temperature measured by the temperature sensor 18 gradually rises later than the temperature measured by the temperature sensor 16 and, thereafter, converges to a specific temperature T₂ (<T₁) (Time t₂).

In the present embodiment, tampering diagnosis is performed based on the difference in temperature behavior. That is, the temperature behavior caused by the difference between the usual flow and the unusual flow is represented as (1) a convergence temperature difference ΔT (=T₁−T₂) and (ii) a time delay Δt (=t₂−t₁) (FIG. 4),

Accordingly, in a case where the convergence temperature difference ΔT and the time delay At are smaller than pre-set thresholds ΔTₜₕ and Δtₜₕ, it can be determined that the radiator 14 is tampered with. This is because, in general, the core of the radiator is constituted only by the unworked portion and the worked portion does not exist so that, if the radiator 14 is tampered with, the temperature behaviors measured by the temperature sensors 16, 18 exhibit similar temperature behaviors. Therefore, according to the present embodiment, it is possible to detect tampering with the radiator 14 with high probability. Note that it is assumed that the above-mentioned thresholds ΔTₜₕ and Δtₜₕ are pre-set according to the degree of the closing work, and are stored in the ECU 40.

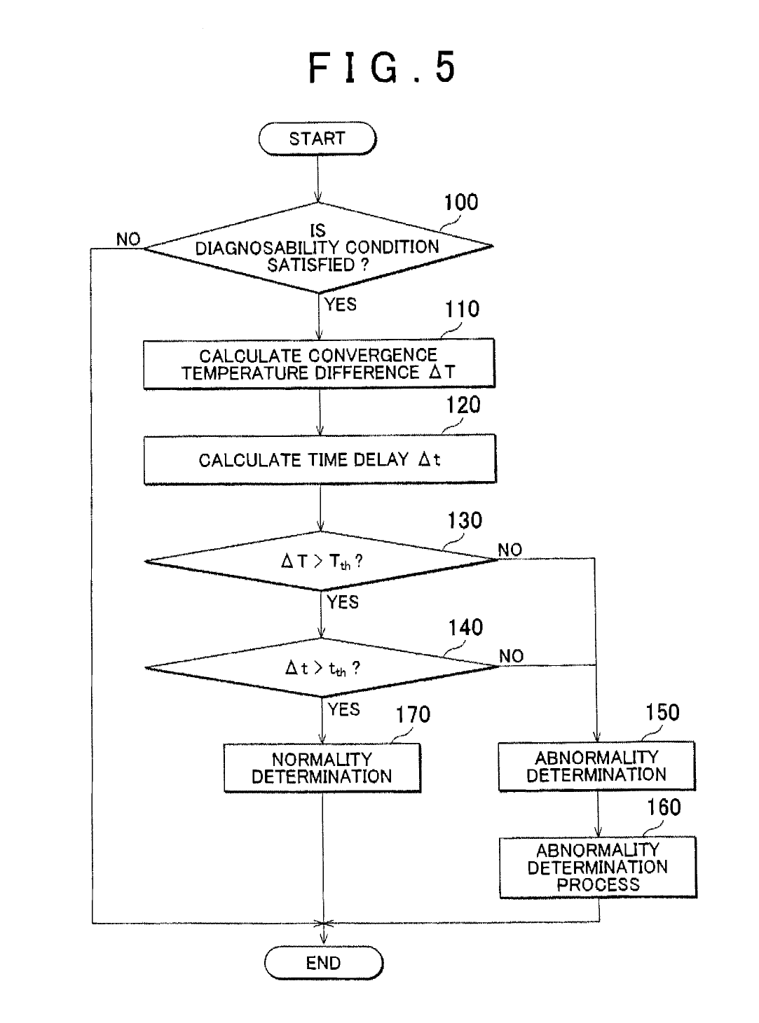

Next, with reference to FIG. 5, the specific method of the above tampering diagnosis will be described. FIG. 5 is a flowchart showing the tampering diagnosis process executed by the ECU 40 in the first embodiment. Note that the routine shown in FIG. 5 is assumed to be periodically executed repeatedly in synchronization with the valve opening timing of the thermostat (preferably the first valve opening timing after the start of the engine).

In the routine shown in FIG. 5, first, the ECU 40 determines whether or not a diagnosability condition is satisfied (step 100). Specifically, the ECU 40 determines whether or not the sensor error of the temperature sensor 16 or 18 is detected. In a case where the sensor error is not detected, the ECU 40 determines that the diagnosability condition is satisfied. Consequently, the ECU 40 advances to step 110. On the other hand, in a case where the sensor error is detected, the ECU 40 determines that the diagnosability condition is not satisfied. Consequently, the ECU 40 ends the present routine.

In step 110, the ECU 40 calculates the convergence temperature difference ΔT. Specifically, after the valve opening of the thermostat, the ECU 40 regards the temperature when the detection value of the temperature sensor 16 is stabilized as the convergence temperature of the unworked portion, regards the temperature when the detection value of the temperature sensor 18 is stabilized as the convergence temperature of the worked portion, and calculates the convergence temperature difference AT based on these convergence temperatures. Note that the stabilization of the detection value of each of the temperature sensors 16, 18 is determined by whether or not a difference between successive detection values falls within a permissible range.

Subsequently, the ECU 40 calculates the time delay Δt (step 120). Specifically, after the valve opening of the thermostat, the ECU 40 regards a time required until the detection value of the temperature sensor 16 is stabilized as a necessary time of the unworked portion, regards a time required until the detection value of the temperature sensor 18 is stabilized as a necessary time of the worked portion, and calculates the time delay Δt based on these necessary times. Note that the stabilization of the detection value of each of the temperature sensors 16, 18 is determined by the same method as in step 110.

Next, the ECU 40 compares the convergence temperature difference ΔT with the threshold ΔTₜₕ (step 130). The convergence temperature difference ΔT is the value calculated in step 110, while the threshold ΔTₜₕ is the value stored in the ECU 40. In a case where the convergence temperature difference ΔT>the threshold ΔTₜₕ is satisfied, it can be determined that the convergence temperature in the unworked portion is sufficiently different from the convergence temperature in the worked portion, and hence the ECU 40 advances to step 140.

In step 130, in a case where the convergence temperature difference ΔT≦the threshold ΔTₜₕ is satisfied, the convergence temperature in the unworked portion is close to the convergence temperature in the worked portion, and it can be determined that the possibility of tampering is high. Consequently, the ECU 40 advances to step 150 and determines that an abnormality is present. In a ease where the ECU 40 determines that the abnormality is present, the ECU 40 performs an abnormality determination process (step 160). Specifically, the ECU 40 issues commands to various actuators such that a driver is notified of the presence of the abnormality by turning on the MIL or driving in a fail-safe mode (e.g., injection amount limit control) is performed.

In step 140, the ECU 40 compares the time delay Δt with the threshold Δtₜₕ. The time delay At is the value calculated in step 120, while the threshold Δtₜₕ is the value stored in the ECU 40. In a case where the time delay Δt>the threshold Δtₜₕ is satisfied, it can be determined that the time required until the convergence temperature is reached in the unworked portion is sufficiently different from the time required until the convergence temperature is reached in the worked portion. Consequently, the ECU 40 advances to step 170, and determines that the radiator 14 is normal. On the other hand, in a case where the time delay Δt≦the threshold Δtₜₕ is satisfied, the above-described times in the unworked portion and the worked portion are close to each other, and it can be determined that the possibility of tampering is high. Consequently, the ECU 40 determines that the abnormality is present, and performs the abnormality determination process such as turning on of the MIL or the like (steps 150, 160).

Thus, according to the routine shown in FIG. 5, by the diagnosis that uses the convergence temperature difference ΔT and the time delay Δt, it is possible to detect tampering with the radiator 14 with high probability.

Incidentally, in the first embodiment described above, the tampering diagnosis is performed based on (i) the convergence temperature difference ΔT and (ii) the time delay Δt, the tampering diagnosis may also be performed based on only one of them. In addition, the tampering diagnosis may also be performed based on the determination parameter other than (I) the convergence temperature difference ΔT and (ii) the time delay Δt. For example, the temperature gradient in a set time after the valve opening of the thermostat may be used as the determination parameter. That is, as long as the tampering diagnosis uses a difference in temperature characteristic between the unworked portion and the worked portion, it is possible to obtain the same effects as those of the present embodiment.

In addition, in the first embodiment described above, although the closed portions 30, 32 are formed by closing both ends of the tube 22, the closed portion may also be formed by closing the middle portion of the tube 22. This is because, if the tube 22 is subjected to the closing work, it is possible to generate the unusual flow of the coolant. However, when the coolant collects in the tube 22, there is a possibility that it is not possible to precisely grasp the temperature characteristics of the worked portion due to the influence by the collecting coolant. Therefore, the position of the closing work is preferably set on the upstream side of the tube 22.

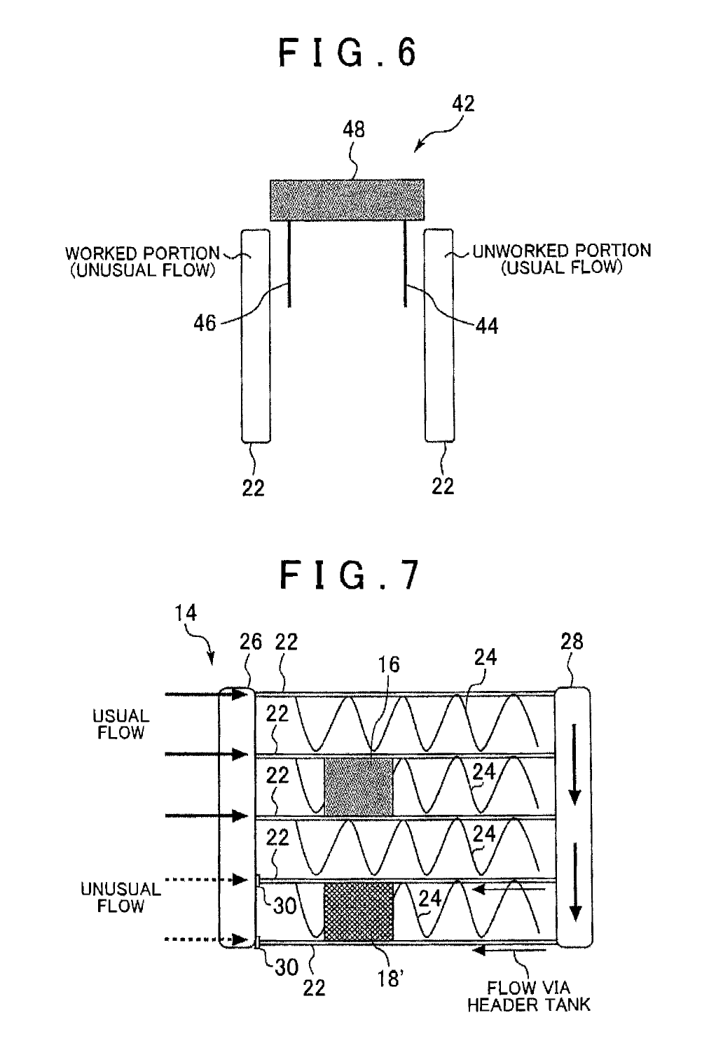

Further, in the first embodiment described above, the configuration is adopted in which the temperature sensors 16, 18 and the ECU 40 are independent of each other, it is also possible to adopt an apparatus configuration in which the temperature measurement function of each of the temperature sensors 16, 18 and the tampering diagnosis function of the ECU 40 are unified. FIG. 6 is a schematic diagram of a diagnosis process apparatus with the temperature measurement function. As shown in FIG. 6, a diagnosis process apparatus 42 includes a temperature measurement unit 44 installed in the unworked portion, a temperature measurement unit 46 installed in the worked portion, and a sensor main body 48. In such an apparatus configuration of the unified functions, the above-described tampering diagnosis process may be performed. Note that the present modification can also be applied in a second embodiment described later.

In addition, in the first embodiment described above, although the description is given by using the radiator 14 as an example, as long as the component is the component of the cooling system having the core structure similar to that of the radiator 14 such as, e.g., an intercooler or a capacitor of an air conditioner, the invention can be applied to the component in the same manner as in the present embodiment. Note that the present modification can also be applied in the second embodiment described later.

Note that, in the first embodiment described above, the unworked portion corresponds to the “cooling portion” of the first aspect of the invention, and the worked portion corresponds to the “non-cooling portion” of the first aspect of the invention. In addition, in the first embodiment described above, the ECU 40 performs the processes of steps 110 to 150 and 170 of FIG. 5 to thereby function as the “abnormality diagnosis portion”.

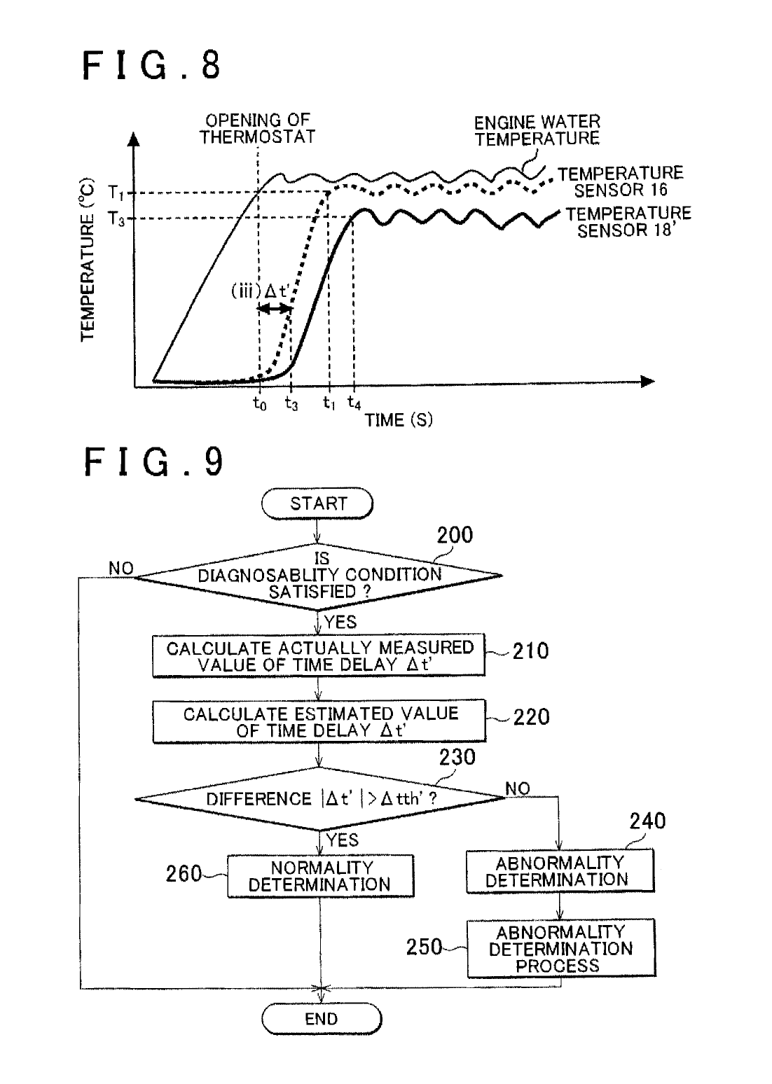

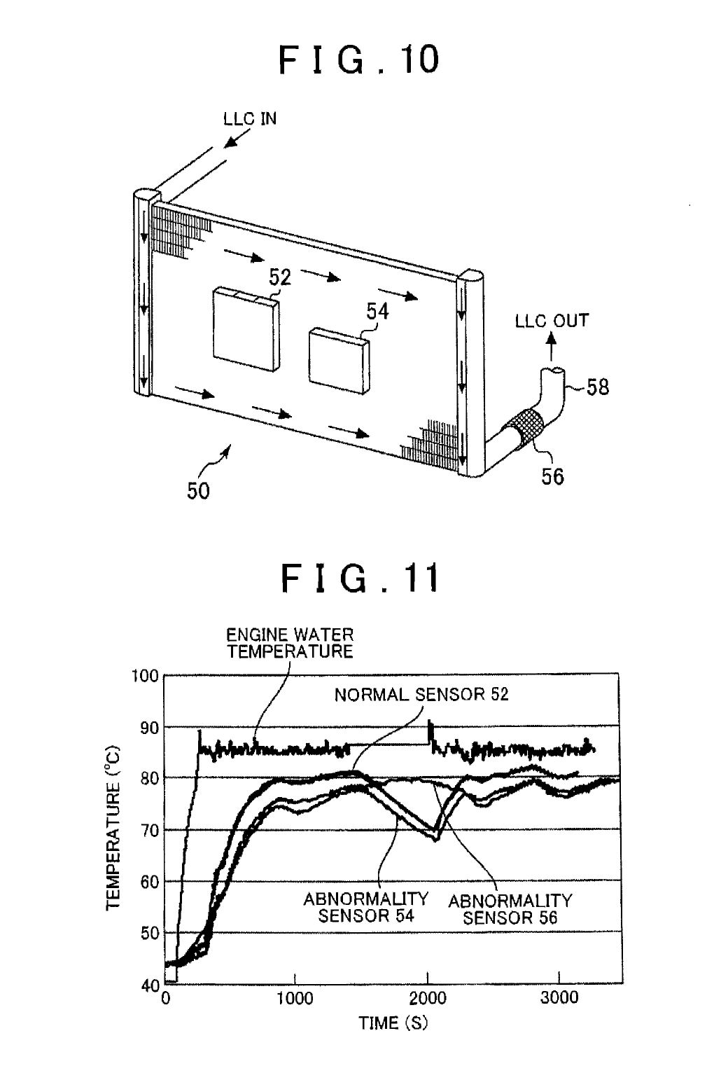

Next, with reference to FIGS. 7 to 9, the second embodiment of the invention will be described. The present embodiment is characterized in that, in the structure of the radiator 14 having only the closed portion 30 (i.e., without the closed portion 32), tampering diagnosis described in conjunction with FIGS. 8 and 9 is executed. Consequently, the description of the configuration of the abnormality diagnosis apparatus and the configuration of the vehicle on which the abnormality diagnosis apparatus is mounted will be omitted. Note that, in the following description, in order to differentiate the present embodiment from the first embodiment described above, the core including the tube 22 formed only with the closed portion 30 is referred to as an “upstream-side worked portion”, and the temperature sensor attached to the upstream-side worked portion is referred to as a “temperature sensor 18”.

FIG. 7 is a view for explaining the flow of the coolant in the radiator 14. The coolant flows into each of the tubes 22 via the header tank 26. Herein, the usual flow of the coolant is generated in the tube 22 that is not subjected to the closing work, and the unusual flow of the coolant is generated in the tube 22 formed with the closed portion 30. The arrangement up to this point is the same as that of the first embodiment. However, in the tube 22 formed with the closed portion 30, the flow of the coolant via the header tank 28 is generated. Consequently, the temperature measured by the temperature sensor 18′ exhibits the behavior different from the behavior of the temperature measured by the temperature sensor 18 of the first embodiment described above.

FIG. 8 is a view for explaining the temperature behaviors measured by the temperature sensors 16, 18. As described in conjunction with FIG. 4, the temperature measured by the temperature sensor 16 sharply rises after the valve opening of the thermostat (Time t₀) to approach the engine water temperature, and converges to the specific temperature T₁ (Time t₁). On the other hand, in the tube 22 formed with the closed portion 30, the flow of the coolant via the header tank 28 is generated. Consequently, the temperature measured by the temperature sensor 18′ starts to rise later than the temperature measured by the temperature sensor 16 (Time t₃) and, thereafter, converges to a specific temperature T₃ (<T₁)(Time t₄).

In the present embodiment, similarly to the first embodiment, the tampering diagnosis is performed based on the difference between the temperature behaviors measured by the temperature sensors 16, 18. The flow of the coolant via the header tank 28 is represented as (iii) a time delay Δt′ in the rise start time of the measured temperature (=t₃−t₁) (FIG. 7). In addition, the time delay Δt′ can be estimated based on the flow rate of the coolant in the radiator 14, the engine water temperature, and the temperature of the unworked portion at the time point of the valve opening of the thermostat. The flow rate of the coolant in the radiator 14 can be estimated from the engine RPM. Accordingly, in a case where a difference |Δt′| between the actually measured value and the estimated value of the time delay Δt′ is larger than a threshold Δt′ₜₕ, it can be determined that the radiator 14 is tampered with. The reason for this is the same as in the first embodiment. That is, in general, the core of the radiator is constituted only by the unworked portion and the upstream-side worked portion does not exist so that, if the radiator 14 is tampered with, the actually measured value and the estimated value of the time delay Δt′ become different from each other. Therefore, according to the present embodiment, it is possible to detect tampering with the radiator 14 with high probability. Note that it is assumed that the above threshold Δt′ₜₕ is pre-set according to the diagnosis accuracy of tampering, and is stored in the ECU 40.

Next, with reference to FIG. 9, the specific method of the above tampering diagnosis will be described. FIG. 9 is a flowchart showing the tampering diagnosis process executed by the ECU 40 in the present embodiment. Note that, similarly to the routine of FIG. 5, the routine shown in FIG. 9 is assumed to be periodically executed repeatedly in synchronization with the valve opening timing of the thermostat.

In the routine shown in FIG. 9, first, the ECU 40 determines whether or not the diagnosability condition is satisfied (step 200). The process in the present step is the same as that in step 100 of FIG. 5.

In step 210, the ECU 40 calculates the actually measured value of the time delay Δt′. Specifically, the ECU 40 calculates, as the time delay Δt′, a time required from the start of rise of the detection value of the temperature sensor 18′ to the valve opening of the thermostat. Note that the start of rise of the detection value of the temperature sensor is detected by whether or not a difference between successive detection values exceeds a set value.

Subsequently, the ECU 40 calculates the estimated value of the time delay Δt′ (step 220). Specifically, the ECU 40 detects the engine RPM from the above crank angle sensor, the engine water temperature from the above engine water temperature sensor, and the temperature of the unworked portion from the temperature sensor 16, and calculates the estimated value of the time delay Δt′ based on these detection values.

Subsequently, the ECU 40 compares the difference |Δt′| between the actually measured value and the estimated value of the time delay Δt′ with the threshold Δt′ₜₕ (step 230). Ad is represented as the difference between the actually measured value calculated in step 210 and the estimated value calculated in step 220. The threshold Δt′ₜₕ is the value stored in the ECU 40. In a case where the difference |Δt′|>the threshold Δt′ₜₕ is satisfied, the above actually measured value is different from the above estimated value, and it can be determined that the possibility of tampering is high. Consequently, the ECU 40 determines that the abnormality is present, and performs the abnormality determination process such as turning on of the MIL or the like (steps 240, 250). On the other hand, in a case where the difference |Δt′|≦the threshold Δt′ₜₕ is satisfied, it can be determined that the above actually measured value and the above estimated value are close to each other, Consequently, the ECU 40 advances to step 260, and determines that the radiator 14 is normal.

Thus, according to the routine shown in FIG. 9, by the diagnosis that uses the difference |Δt′| between the actually measured value and the estimated value of the time delay Δt′, it is possible to detect tampering with the radiator 14 with high probability.

Incidentally, in the second embodiment described above, although the tampering diagnosis is performed based on (iii) the time delay Δt′, the tampering diagnosis may also be performed based on (i) the convergence temperature difference ΔT or (ii) the time delay Δt of the first embodiment together with the (iii) the time delay Δt′. That is, as long as the tampering diagnosis uses the difference in temperature characteristic between the unworked portion and the worked portion, it is possible to obtain the same effects as those of the present embodiment.

Note that, in the second embodiment described above, the header tank 28 corresponds to the “common flow path” of the fourth aspect of the invention.

Next, a third embodiment of the invention will be described. The present embodiment is characterized in that the closed portions 30, 32 of the first embodiment are formed of a material that has a low thermal conductivity such as a silicon bond or the like, and has a thermal expansion coefficient higher than that of the material used for the core of the radiator 14. Consequently, in the following, only this characteristic material will be described, and the description of the configuration of the abnormality diagnosis apparatus and the configuration of the vehicle on which the abnormality diagnosis apparatus is amounted will be omitted.

In a case where the closed portions 30, 32 are formed of the material having the low thermal conductivity, it becomes possible to generate the difference in temperature characteristic described above while minimizing a reduction in the cooling capability of the radiator 14 caused by the closing work. In addition, it also becomes possible to prevent an increase in the temperature of each of the closed portions 30, 32. Further, in a case where the closed portions 30, 32 are formed of the material having the thermal expansion coefficient higher than that of the material used for the core of the radiator 14, it is possible to prevent formation of a gap between each of the closed portions 30, 32 and the tube 22 during the rise of the temperature of the radiator 14, and hence the prediction of the difference in temperature characteristic described above is facilitated so that it is possible to detect the tampering with higher accuracy.

What is claimed is;:

1. An abnormality diagnosis apparatus for a cooling system for cooling a coolant, comprising:
a cooling portion that is formed in a component of the cooling system and includes an internal flow path for flowing the coolant;
a non-cooling portion that is formed in the component and includes a closed flow path obtained by closing at least a part of the internal flow path; and
an abnormality diagnosis portion that performs abnormality diagnosis of the cooling system based on a temperature characteristic of the cooling portion and a temperature characteristic of the non-cooling portion during flowing of the coolant,

2. The abnormality diagnosis apparatus according to claim 1, wherein
the abnormality diagnosis portion performs the abnormality diagnosis based on a difference between a convergence temperature of the non-cooling portion and a convergence temperature of the cooling portion that are obtained after start of the flowing of the coolant into the internal flow path,

3. The abnormality diagnosis apparatus according to claim 1, wherein
the abnormality diagnosis portion performs the abnormality diagnosis based on a difference between a time required for a temperature of the non-cooling portion to converge and a time required for a temperature of the cooling portion to converge after start of the flowing of the coolant into the internal flow path.

4. The abnormality diagnosis apparatus according to claim 1, wherein
the coolant is for cooling an internal combustion engine,
the internal flow path includes a shared common flow path on a downstream side of the internal flow path,
the closed flow path is formed by closing a part of the internal flow path on an upstream side and is structured to allow the coolant from the common flow path to flow backward, and
the abnormality diagnosis portion estimates a necessary time required for a temperature of the non-cooling portion to converge after start of the flowing of the coolant into the internal flow path based on an RPM of the internal combustion engine, a coolant temperature on the upstream side of the internal flow path, and a temperature of the cooling potion at a time point of the start of the flowing of the coolant into the internal flow path, and performs the abnormality diagnosis by comparing the estimated necessary time with an actual necessary time required for the temperature of the non-cooling portion to converge after the start of the flowing of the coolant into the internal flow path.

5. The abnormality diagnosis apparatus according to claim 1, wherein
the closed flew path is formed of a material having a thermal conductivity lower than that of a material used for the internal flow path.

6. The abnormality diagnosis apparatus according to claim 1, wherein
the closed flow path is formed of a material having a thermal expansion coefficient higher than that of a material used for the internal flow path.

7. The abnormality diagnosis apparatus according to claim 1, wherein
an alarm lamp is turned on or driving in a fail-safe mode is performed when an abnormality in the cooling system is determined as a result of the abnormality diagnosis.
